(19) United States
(12) Patent Application Publication
(10) Pub. No.: US 2011/0182057 A1
(43) Pub. Date: Jul. 28, 2011

(54) Wrist flashlight

(76) Inventor: Rick Wayne Watson, Tarpon Springs, FL (US)

(21) Appl. No.: 12/657,787

(22) Filed: Jan. 28, 2010

(51) Int. Cl. F21L 4/00; F21V 21/08

(52) U.S. Cl. 362/103

(57) ABSTRACT

A means to provide illumination in tight confined spaces and to allow this device to be attached to multiple devices with a extended length of the strap

### FIELD OF THE INVENTION

The present invention relates in general to flashlights, and in particular to a flashlight that is adapated to be worn on the wrist of the user. To be attached to tools or other objects that illumination is needed.

### BACKGROUND OF THE INVENTION

There are requirements for illumination in tightly confined spaces where local light is blocked such as a auto repair mechanic where the interior of the engine is poorly illuminated or a builder craftsman that requires illumination in a tight confined corner of a roof or attic. There are numerous wrist mounted flashlights that are too bulky and do not provide a solution to these requirements. There is also many wrist mounted flashlights assembles that cannot be strapped to an electrical drill or drilling screws in tight places. There are many wrist mounted flashlights that are too large for tightly confined spaces.

U.S. Design Pat. Des 344,411

U.S. Pat. No. 1,769,241

U.S. Pat. No. 4,788,631

U.S. Pat. No. 5,568,971

U.S. Pat. No. 5,601,356

U.S. Pat. No. 6,213,619

U.S. design Pat. Des 344,411 This Design Patent has numerous parts that can be removed and not used; such as the hinge mounting; and this shown flashlight is too large for confined spaces. The wristband is too short for the invention to be mounted to an electrical powered drill to illuminate a darkly lit corner of a roof or attic. This design when used, the finger and upper palm would obscure the illumination from the flashlight when used. The reduction in parts would allow an inexpensive product to be marketed and sold on the open market.

U.S. Pat. No. 1,769,241 This Patent has excessive numerous parts that can be removed and not used, such as the angled mount piece; and this invention is too large for confined spaces. The wristband is too short for the invention to be mounted to an electrical powered drill to illuminate a darkly lit corner of a roof or attic. The reduction in parts would allow an inexpensive product to be marketed and sold on the open market.

U.S. Pat. No. 4,788,631 This Patent has excessive numerous parts that can be removed and not used, such as the dual battery assembly, it can be reduced down to a single battery source. The wristband is too short for the invention to be mounted to an electrical powered drill to illuminate a darkly lit corner of a roof or attic. The reduction in parts would allow an inexpensive product to be marketed and sold on the open market.

U.S. Pat. No. 5,568,971 The wristband is too short for the invention to be mounted to an electrical powered drill to illuminate a darkly lit corner of a roof or attic. There are a multiple miniaturized parts to be created and employed in the main compartment of this invention. This is expensive to produce and manufacture, this inventors usage of a reduction in the amount of parts to be created and inexpensive miniaturized parts is a improvement over this prior art and invention. The current illumination of the prior art invention is too small to be of a practical used in everyday environment.

U.S. Pat. No. 5,601,356 This Patent has excessive numerous parts that can be removed and not used, such as the hinged mount piece for the flashlight; and this invention is too large for confined spaces. The wristband is too short for the invention to be mounted to an electrical powered drill to illuminate a darkly lit corner of a roof or attic. The reduction in parts would allow an inexpensive product to be marketed and sold on the open market.

U.S. Pat. No. 6,213,619 B1 This Patent has excessive numerous parts that can be removed and not used, such as the mounting piece for the illumination device; and this invention is too large for confined spaces. The wristband is too short for the invention to be mounted to an electrical powered drill to illuminate a darkly lit corner of a roof or attic. The reduction in parts would allow an inexpensive product to be marketed and sold on the open market.

It is therefore an object of the invention to provide illumination in tight confined spaces.

It is another object of the invention to be attached to other objects that require illumination in tight confined spaces or areas of illumination.

It in another object of the invention to reduce the amount of parts needed to create a wrist mounted flashlights, thereby reducing manufacturing costs in the construction of these devices.

It is another object of the invention to reduce the amount of lost man hours by providing a easy means of illumination in tightly confined spaces such as car engine repair by having the illumination attached to the wrist instead of overhead hanging lights with extension cords.

### SUMMARY OF THE INVENTION

In accordance with the present invention, there is provided a means to provide illumination in tight confined spaces and to allow this device to be attached to multiple devices with a extended length of the strap

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a FIG. 1 number 1 is machined stitches to secure a loop to hold the d ring for the wrist light band. FIG. 1 number 2 is a machined weave cotton strap 1 inch in width and 13 inches in length. FIG. 1 number 3 is the adhesive bonded Velcro loop with machined stitches to secure the Velcro to the wrist light band. FIG. 1 number 4 is the adhesive bonded Velcro hook with machined stitches to secure to the wrist light band. FIG. 1 number 5 is the mini flashlight. FIG. 1 number 6 is the elastic band that encircles the mini flashlight and is stretched to secure the mini flashlight to the wrist light band. FIG. 1 number 7 is the adhesive bonded Velcro loop that has machined stitches to secure the Velcro loop to the wrist light band;

FIG. 2 is a perspective view of a FIG. 2 number 10 is the supporting case for the mini flashlight. FIG. 2 number 11 is the electrical conducting metal strip that connects the bent electrical contact to the spring and negative charged battery side to the front of the mini flashlight. FIG. 2 number 12 is a battery that supplies power and voltage to the led circuit. FIG. 2 number 13 is the outer insulated boot that covers the switch. FIG. 2 number 14 is the push on and off switch for the mini flashlight. FIG. 2 number 15 is the bent electrical contact that maintains contact when the push switch is pressed into the center of the mini flashlight. FIG. 2 number 16 is the support structure for the spring that maintains contact between the battery and the electrical contact support structure. FIG. 2 number 17 is the spring that maintains electrical contact between the negative charged battery and the electrical contact support structure. FIG. 2 number 18 is the common junction point of the positive side of the light emitting diodes to the electrical contact of the positive side of the battery. FIG. 2 number 19 is the inner and outer threads of the outer support structure. FIG. 2 number 20 is the outer support structure of the led assembly to support the light emitting diodes. FIG. 2 number 21 is the electrical wire that connects the light emitting diode negative electrical wire to the common electrical bus. FIG. 2 number 22 is the light emitting diode. FIG. 2 number 23 is the common support structure that holds all the light emitting diodes in place. FIG. 2 number 24 common negative electrical bus that connects all the light emitting diodes to the negative electrical strip that connects to the negative side of the battery. FIG. 2 number 25 is the inner and outer threads of the outer support structure. FIG. 2 number 26 is the electronic schematic representation of the electrical connection from the push switch to the positive side of the anode of the light emitting diode. FIG. 2 number 27 is the electronic schematic representation of the electrical push switch that connects the positive side of the battery to the positive side of the anode. FIG. 2 number 28 is the electronic schematic representation of the battery for the mini flashlight. FIG. 2 number 29 is the electronic schematic representation of the negative side of the connection from the battery to the cathode of the light emitting diode. FIG. 2 number 30 is 1 of 5 light emitting diodes. FIG. 2 number 31 is the 2 of 5 light emitting diodes. FIG. 2 number 32 is the 3 of 5 light emitting diodes. FIG. 2 number 33 is 4 of 5 light emitting diodes. FIG. 2 number 34 is the 5 of 5 light emitting diodes which shows electrical illumination as the diode is conducting electricity when the s1 switch is closed. FIG. 2 number 35 is the photon energy that is emitted as light;

FIG. 3 is a perspective view of a FIG. 3 number 36 is a representation of a battery powered electrical drill with attached battery. FIG. 3 number 37 is the wrist band light strap that is secured to the housing of the electrical drill. FIG. 3 number 38 is the mini flash light with the switch depressed to allow light to be illuminated. FIG. 3 number 39 is the representation of the light that is emitted from the mini flash light to illuminate the area of work to be done;

FIG. 4 is a perspective view of a FIG. 4 number 40 is the arm of the user that has the wrist light fastened to ones wrist. FIG. 4 number 41 is the mini flash light that is secured below the wrist to allow access in a narrow confinement space. FIG. 4 number 42 is the strap that is secured and encircled the wrist of the user. FIG. 4 number 43 is the hand of the user that has gripped the tool that is to be used in this enclosed confined space. FIG. 4 number 44 is the representation of a confined edge of a compartment, like a motor engine that the mechanic requires illumination to perform work. FIG. 4 number 45 is the light cone that is created from the illumination of the mini flashlight. FIG. 4 number 46 is the representation of a tool that illumination is required to perform work. FIG. 4 number 47 is the representation of a surface that is confined and illumination is provided from the mini flash light. FIG. 4 number 48 is a representation of a confined edge of a compartment, like a motor engine that the mechanic requires illumination to perform work;

FIG. 5 is a perspective view of a FIG. 5 number 48 is a alternative embodiment of the wrist flashlight inner loop of wrist band material with the Velcro loop attached with adhesive to the inner loop of wrist band material. FIG. 5 number 49 is the Velcro hook that is attached with adhesive to the outer loop of wrist band material. FIG. 5 number 50 is the machined switch that secures the loop of wrist band material to the elongated loop hole of the support structure of the mini flashlight. FIG. 5 number 51 is the loop of wrist band material that has looped to the elongated loop hole of the support structure of the mini flashlight. FIG. 5 number 52 is the support structure that is a single piece construction that supports the mini flashlight and has two elongated loop holes to allow the wrist band material to be loop back upon itself. FIG. 5 number 53 is the hole that the mini flash light is to slide into and be secured. FIG. 5 number 54 is the circular portion of the support structure that is used to support and secure the mini flashlight to the wrist band material. FIG. 5 number 55 is the support structure that is extended to create an elongated loop holes to allow the wrist band material to be looped back upon itself. FIG. 5 number 56 is the wrist band material that is looped though the support structured in the elongated loop hole back upon itself to provide maximum length of wrist band material to allow additional options that the mini flashlight can be secured itself to other structures; and

FIG. 6 is a perspective view of a FIG. 6 number 57 is the top view of the outer insulated boot that protects the switch to turn the mini flashlight on. FIG. 6 number 58 is the top structure of a single piece construction that encircles the mini flash light and provides support for the mini flashlight. FIG. 6 number 59 is the wrist band that encircles the users wrist when the band is worn. FIG. 6 number 60 is the machined switching that secures the wrist band strap to the support structure. FIG. 6 number 61 is the folded wrist band material through the elongated loop back upon itself and secured to itself. FIG. 6 number 62 is the elongated loop hole that allows the wrist band material to be looped back upon itself. FIG. 6 number 63 is the support structure that connects the elongated loop hole to the support structure for the mini flashlight. FIG. 6 number 64 is the light emitting led diode of the mini flash light. FIG. 6 number 73 is the edge of the light cone that is created from the light emitting diode. FIG. 6 number 74 is the edge of the light cone that is created from the light emitting diode. FIG. 6 number 65 is the light that is used to illuminate the area of work to be performed. FIG. 6 number 66 is the light emitting led diode of the mini flash light. FIG. 6 number 67 is the housing that supports the light emitting diodes. FIG. 6 number 68 is the boundary where the mini flashlight can be taken unscrewed and taken apart for battery replacement. FIG. 6 number 69 is the folded edge of the wrist band that encircles the users wrist. FIG. 6 number 70 is the loop side of the Velcro material that is attached with adhesive to the wrist hand material. FIG. 6 number 71 is the wrist band that encircles the users wrist when the band is worn. FIG. 6 number 72 is the support structure that connected the elongated loop hole to the support structure for the mini flashlight to be supported.

For purposes of clarity and brevity, like elements and components will bear the same designations and numbering throughout the FIGURES.

### DESCRIPTION OF THE PREFERRED EMBODIMENT

The wrist mounted mini flashlight 18 is mounted to a strap 10 that is constructed to encircle the d ring for an extended length beyond normal construction of wrist straps. The flashlight 18 is to be used on the underside of the wrist. This allows access to tight confined spaces where normal flashlights, overhead hanging lights cannot illuminate the desired area to be illuminated. By using the underside of the wrist the topside of the wrist is allowed to be pressed against the confining surface such as a engine block in a car or the interior of a oven or stove. The extended length allows the flashlight 18 to be mounted on a electrical drill or device that allows the strap 10 to be securely placed.

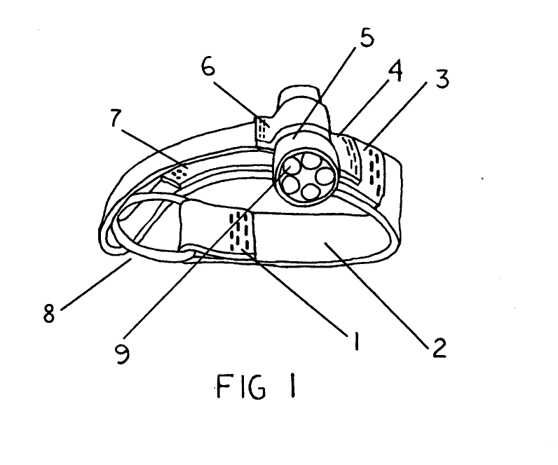

FIG. 1 is a perspective view of a FIG. 1 number 1 is machined stitches 20 to secure a loop to hold the d ring for the wrist light band. FIG. 1 number 2 is a machined weave cotton strap 10 1 inch in width and 13 inches in length. FIG. 1 number 3 is the adhesive 22 bonded Velcro 16 loop with machined stitches 20 to secure the Velcro 16 to the wrist light band. FIG. 1 number 4 is the adhesive 22 bonded Velcro 16 hook with machined stitches 20 to secure to the wrist light band. FIG. 1 number 5 is the mini flashlight 18. FIG. 1 number 6 is the elastic 14 band that encircles the mini flashlight 18 and is stretched to secure the mini flashlight 18 to the wrist light band. FIG. 1 number 7 is the adhesive 22 bonded Velcro 16 loop that has machined stitches 20 to secure the Velcro 16 loop to the wrist light band.

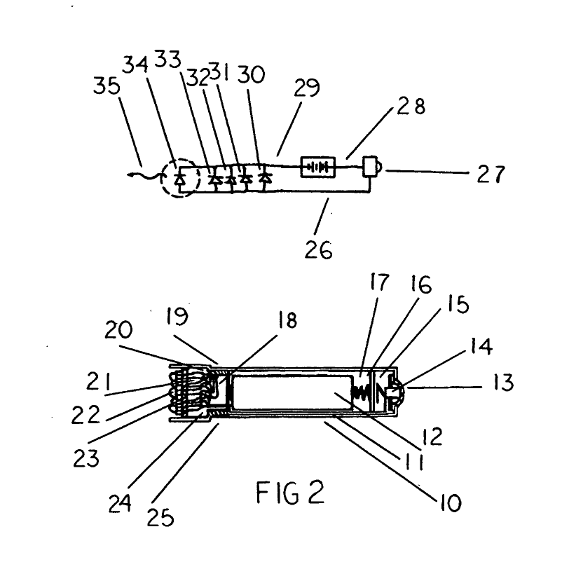

FIG. 2 is a perspective view of a FIG. 2 number 10 is the supporting case for the mini flashlight 18. FIG. 2 number 11 is the electrical conducting metal strip that connects the bent electrical contact to the spring and negative charged battery side to the front of the mini flashlight 18. FIG. 2 number 12 is a battery that supplies power and voltage to the led circuit. FIG. 2 number 13 is the outer insulated boot that covers the switch. FIG. 2 number 14 is the push on and off switch for the mini flashlight 18. FIG. 2 number 15 is the bent electrical contact that maintains contact when the push switch is pressed into the center of the mini flashlight 18. FIG. 2 number 16 is the support structure for the spring that maintains contact between the battery and the electrical contact support structure. FIG. 2 number 17 is the spring that maintains electrical contact between the negative charged battery and the electrical contact support structure. FIG. 2 number 18 is the common junction point of the positive side of the light emitting diodes to the electrical contact of the positive side of the battery. FIG. 2 number 19 is the inner and outer threads of the outer support structure. FIG. 2 number 20 is the outer support structure of the led assembly to support the light emitting diodes. FIG. 2 number 21 is the electrical wire that connects the light emitting diode negative electrical wire to the common electrical bus. FIG. 2 number 22 is the light emitting diode. FIG. 2 number 23 is the common support structure that holds all the light emitting diodes in place. FIG. 2 number 24 common negative electrical bus that connects all the light emitting diodes to the negative electrical strip that connects to the negative side of the battery. FIG. 2 number 25 is the inner and outer threads of the outer support structure. FIG. 2 number 26 is the electronic schematic representation of the electrical connection from the push switch to the positive side of the anode of the light emitting diode. FIG. 2 number 27 is the electronic schematic representation of the electrical push switch that connects the positive side of the battery to the positive side of the anode. FIG. 2 number 28 is the electronic schematic representation of the battery for the mini flashlight 18. FIG. 2 number 29 is the electronic schematic representation of the negative side of the connection from the battery to the cathode of the light emitting diode. FIG. 2 number 30 is 1 of 5 light emitting diodes. FIG. 2 number 31 is the 2 of 5 light emitting diodes. FIG. 2 number 32 is the 3 of 5 light emitting diodes. FIG. 2 number 33 is 4 of 5 light emitting diodes. FIG. 2 number 34 is the 5 of 5 light emitting diodes which shows electrical illumination as the diode is conducting electricity when the s1 switch is closed. FIG. 2 number 35 is the photon energy that is emitted as light.

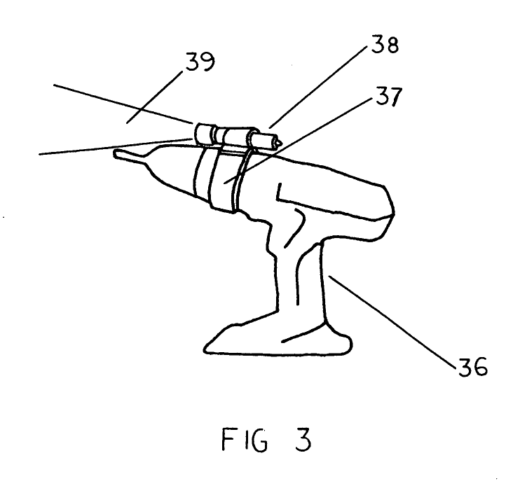

FIG. 3 is a perspective view of a FIG. 3 number 36 is a representation of a battery powered electrical drill with attached battery. FIG. 3 number 37 is the wrist band light strap 10 that is secured to the housing of the electrical drill. FIG. 3 number 38 is the mini flash light with the switch depressed to allow light to be illuminated. FIG. 3 number 39 is the representation of the light that is emitted from the mini flash light to illuminate the area of work to be done.

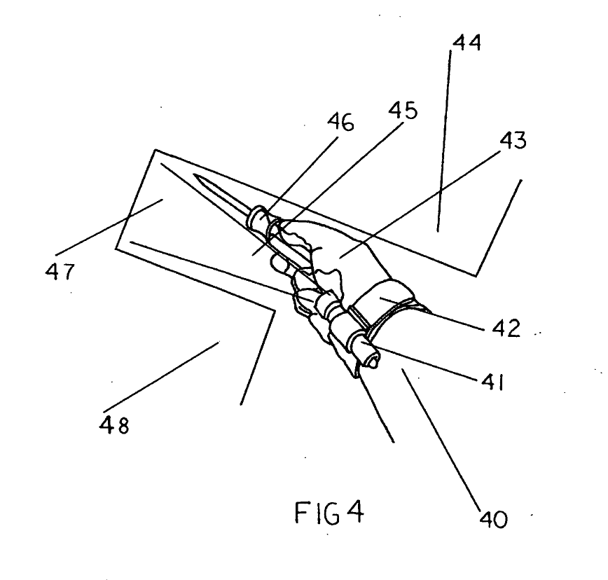

FIG. 4 is a perspective view of a FIG. 4 number 40 is the arm of the user that has the wrist light fastened to ones wrist. FIG. 4 number 41 is the mini flash light that is secured below the wrist to allow access in a narrow confinement space. FIG. 4 number 42 is the strap 10 that is secured and encircled the wrist of the user. FIG. 4 number 43 is the hand of the user that has gripped the tool that is to be used in this enclosed confined space. FIG. 4 number 44 is the representation of a confined edge of a compartment, like a motor engine that the mechanic requires illumination to perform work. FIG. 4 number 45 is the light cone that is created from the illumination of the mini flashlight 18. FIG. 4 number 46 is the representation of a tool that illumination is required to perform work. FIG. 4 number 47 is the representation of a surface that is confined and illumination is provided from the mini flash light. FIG. 4 number 48 is a representation of a confined edge of a compartment, like a motor engine that the mechanic requires illumination to perform work.

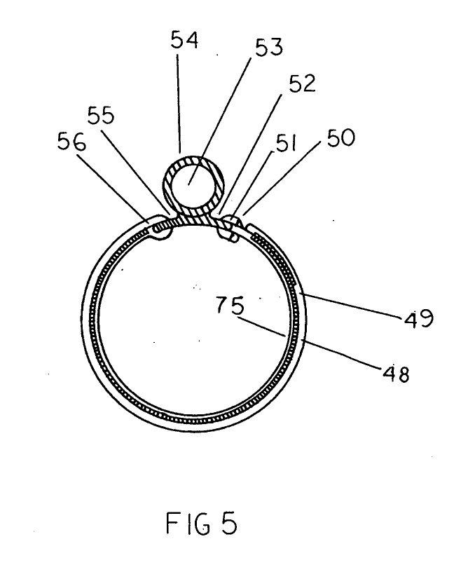

FIG. 5 is a perspective view of a FIG. 5 number 48 is a alternative embodiment of the wrist flashlight 18 inner loop of wrist band material with the Velcro 16 loop attached with adhesive 22 to the inner loop of wrist band material. FIG. 5 number 49 is the Velcro 16 hook that is attached with adhesive 22 to the outer loop of wrist band material. FIG. 5 number 50 is the machined switch that secures the loop of wrist band material to the elongated loop hole of the support structure of the mini flashlight 18. FIG. 5 number 51 is the loop of wrist band material that has looped to the elongated loop hole of the support structure of the mini flashlight 18. FIG. 5 number 52 is the support structure that is a single piece construction that supports the mini flashlight 18 and has two elongated loop holes to allow the wrist band material to be loop back upon itself. FIG. 5 number 53 is the hole that the mini flash light is to slide into and be secured. FIG. 5 number 54 is the circular portion of the support structure that is used to support and secure the mini flashlight 18 to the wrist band material. FIG. 5 number 55 is the support structure that is extended to create an elongated loop holes to allow the wrist band material to be looped back upon itself. FIG. 5 number 56 is the wrist band material that is looped though the support structured in the elongated loop hole back upon itself to provide maximum length of wrist band material to allow additional options that the mini flashlight 18 can be secured itself to other structures.

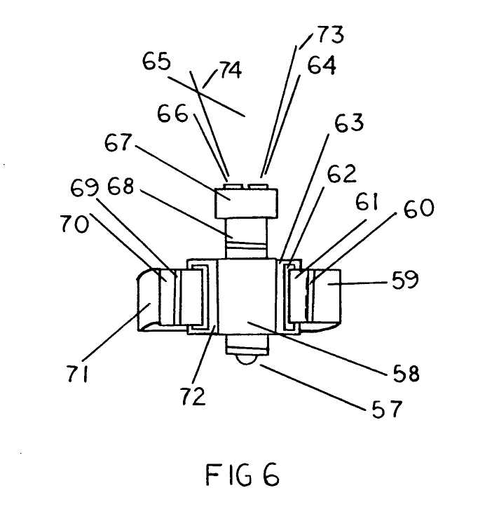

FIG. 6 is a perspective view of a FIG. 6 number 57 is the top view of the outer insulated boot that protects the switch to turn the mini flashlight 18 on. FIG. 6 number 58 is the top structure of a single piece construction that encircles the mini flash light and provides support for the mini flashlight 18. FIG. 6 number 59 is the wrist band that encircles the users wrist when the band is worn. FIG. 6 number 60 is the machined switching that secures the wrist band strap 10 to the support structure. FIG. 6 number 61 is the folded wrist band material through the elongated loop back upon itself and secured to itself. FIG. 6 number 62 is the elongated loop hole that allows the wrist band material to be looped back upon itself. FIG. 6 number 63 is the support structure that connects the elongated loop hole to the support structure for the mini flashlight 18. FIG. 6 number 64 is the light emitting led diode of the mini flash light. FIG. 6 number 73 is the edge of the light cone that is created from the light emitting diode. FIG. 6 number 74 is the edge of the light cone that is created from the light emitting diode. FIG. 6 number 65 is the light that is used to illuminate the area of work to be performed. FIG. 6 number 66 is the light emitting led diode of the mini flash light. FIG. 6 number 67 is the housing that supports the light emitting diodes. FIG. 6 number 68 is the boundary where the mini flashlight 18 can be taken unscrewed and taken apart for battery replacement. FIG. 6 number 69 is the folded edge of the wrist band that encircles the users wrist. FIG. 6 number 70 is the loop side of the Velcro 16 material that is attached with adhesive 22 to the wrist hand material. FIG. 6 number 71 is the wrist band that encircles the users wrist when the band is worn. FIG. 6 number 72 is the support structure that connected the elongated loop hole to the support structure for the mini flashlight 18 to be supported.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A wrist flashlight for hands free illumination of an area where work or activity is to be performed comprising:
means for securing the flashlight to the wrist;
means for securing wristband to the user, securely encircling to said means for securing the flashlight to the wrist;
means for securing the flashlight to the strap;
means for to provide a catch and release mechanism, threadably fastened to said means for securing the flashlight to the wrist;
means for illumination of a surface or object, snugly fitted to said means for securing the flashlight to the strap; and
means for secure two elements together, threadably fastened to said means for securing the flashlight to the strap, and supportively embedded to said means for securing the flashlight to the wrist.

2. The wrist flashlight in accordance with claim 1, wherein said means for securing the flashlight to the wrist comprises a strap.

3. The wrist flashlight in accordance with claim 1, wherein said means for securing wristband to the user comprises a d-ring.

4. The wrist flashlight in accordance with claim 1, wherein said means for securing the flashlight to the strap comprises an elastic.

5. The wrist flashlight in accordance with claim 1, wherein said means for to provide a catch and release mechanism comprises a velcro.

6. The wrist flashlight in accordance with claim 1, wherein said means for illumination of a surface or object comprises a flashlight.

7. The wrist flashlight in accordance with claim 1, wherein said means for secure two elements together comprises a stitches.

8. A wrist flashlight for hands free illumination of an area where work or activity is to be performed comprising:
a strap, for securing the flashlight to the wrist;
a d-ring, for securing wristband to the user, securely encircling to said Strap;
an elastic, for securing the flashlight to the strap;
a velcro, for to provide a catch and release mechanism, threadably fastened to said Strap;
a flashlight, for illumination of a surface or object, snugly fitted to said elastic; and
a stitches, for secure two elements together, threadably fastened to said elastic, and supportively embedded to said Strap.

9. The wrist flashlight as recited in claim 8, further comprising:
an adhesive, for connection of two elements together, securely constructed to said Velcro.

10. A wrist flashlight for hands free illumination of an area where work or activity is to be performed comprising:
a strap, for securing the flashlight to the wrist;
a d-ring, for securing wristband to the user, securely encircling to said Strap;
an elastic, for securing the flashlight to the strap;
a velcro, for to provide a catch and release mechanism, threadably fastened to said Strap;
a flashlight, for illumination of a surface or object, snugly fitted to said elastic;
a stitches, for secure two elements together, threadably fastened to said elastic, and supportively embedded to said Strap; and
an adhesive, for connection of two elements together, securely constructed to said Velcro.
